(19) United States
(12) Patent Application Publication
(10) Pub. No.: US 2026/0003753 A1
(43) Pub. Date: Jan. 1, 2026

(54) DEBUG CIRCUIT TO FREEZE SYSTEM DATAPATHS

(71) Applicant: Advanced Micro Devices, Inc., Santa Clara, CA (US)

(72) Inventors: Hui PENG, Santa Clara, CA (US); Michael Brian GALLES, Los Altos, CA (US)

(21) Appl. No.: 18/758,287

(22) Filed: Jun. 28, 2024

(51) Int. Cl. G06F 11/22; G06F 11/07; G06F 11/273

(52) U.S. Cl. CPC G06F 11/2236; G06F 11/079; G06F 11/2733

(57) ABSTRACT

Embodiments herein describe a system configured to transmit a freeze signal to all of a plurality of logic blocks within the system when an error or trigger event is detected in a logic block and allow each logic block to determine how to respond to the freeze signal, generate a freeze clock signal provided to a main functional logic of the logic block while permitting status and memory content to be read when the logic block enters into a clock freeze mode, generate a status freeze signal to stop a trace logic block from tracing incoming data, and collect a debug status of each of the plurality of logic blocks at a time the error or trigger event was detected or collect statistics within a same time sampling window across the system to perform a debug operation.

### TECHNICAL FIELD

Examples of the present disclosure generally relate to debugging mechanisms, and in particular, to a debug circuit for freezing datapaths chip-wide.

### BACKGROUND

Debugging datapaths involves identifying and resolving issues related to the flow of data throughout the system.

The debugging process may begin by understanding datapath architectures. This includes identifying the various components involved in data processing, their interconnections, and their roles in executing instructions. Then the specific issue or error occurring in the datapath is identified. This could involve incorrect results, unexpected behavior, or failure to execute instructions correctly. The flow of control signals is then traced through the datapath to ensure that they are correctly activating the appropriate components at the right times. A verification takes place to determine whether the data is being transferred correctly between registers and other components of the datapath. Issues may include data corruption, incorrect data values, or improper handling of data transfers. Debugging tools such as waveform viewers, logic analyzers, and simulators may be employed to visualize the operation of the datapath and identify any anomalies or errors. However, typical debugging tools are deficient in determining the root cause of a failure because once an error condition occurs, an extended sequence of datapath events can obscure the original issues.

Accordingly, there is a need to develop improved systems and methods for debugging chips.

### SUMMARY

One embodiment described herein is a system including a debug circuit placed within the system with connectivity to a central processing unit (CPU), the system configured to transmit a freeze signal to all of a plurality of logic blocks within the system when an error or trigger event is detected in a logic block of the plurality of logic blocks and allow each logic block of the plurality of logic blocks to determine how to respond to the freeze signal, generate, by a debug freeze controller, a freeze clock signal provided to a main functional logic of the logic block while permitting status and memory content to be read when the logic block enters into a clock freeze mode, generate, by the debug freeze controller, a status freeze signal to stop a trace logic block from tracing incoming data, and collect a debug status of each of the plurality of logic blocks at a time the error or trigger event was detected or collect statistics within a same time sampling window across the system to perform a debug operation to determine a cause for the error or the trigger event.

One embodiment described herein is an integrated circuit (IC) including a datapath and a debug circuit in communication with the datapath, the IC configured to transmit a freeze signal to all of a plurality of logic blocks within the system when an error or trigger event is detected in a logic block of the plurality of logic blocks and allow each logic block of the plurality of logic blocks to determine how to respond to the freeze signal, generate, by a debug freeze controller, a freeze clock signal provided to a main functional logic of the logic block while permitting status and memory content to be read when the logic block enters into a clock freeze mode, generate, by the debug freeze controller, a status freeze signal to stop a trace logic block from tracing incoming data, and collect a debug status of each of the plurality of logic blocks at a time the error or trigger event was detected or collect statistics within a same time sampling window across the IC to perform a debug operation to determine a cause for the error or the trigger event.

One embodiment described herein is a method including transmitting a freeze signal to all of a plurality of logic blocks within a system when an error or trigger event is detected in a logic block of the plurality of logic blocks and allow each logic block of the plurality of logic blocks to determine how to respond to the freeze signal, generating, by a debug freeze controller, a freeze clock signal provided to a main functional logic of the logic block while permitting status and memory content to be read when the logic block enters into a clock freeze mode, generating, by the debug freeze controller, a status freeze signal to stop a trace logic block from tracing incoming data, and collecting a debug status of each of the plurality of logic blocks at a time the error or trigger event was detected or collecting statistics within a same time sampling window across the system to perform a debug operation to determine a cause for the error or the trigger event.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a system including a network-on-chip (NoC) in communication with various components, where a debug circuit is coupled to each component, according to an example.

FIG. 2 illustrates a datapath including a plurality of logic blocks, according to an example.

FIG. 3 illustrates a flowchart for implementing the debug circuit of FIG. 1 to freeze signals to the datapaths of the system, according to an example.

FIG. 4 illustrates a debug circuit, according to an example.

FIG. 5 illustrates a freeze control function of the debug circuit, according to an example.

FIG. 6 illustrates a packet bus freeze function of the debug circuit, according to an example.

FIG. 7 illustrates a packet bus statistics function of the debug circuit, according to an example.

FIG. 8 illustrates a timing diagram of the packet bus statistics function of the debug circuit, according to an example.

FIG. 9A illustrates a packet latency function of the debug circuit, according to an example.

FIG. 9B illustrates a packet processing of the packet latency function of the debug circuit, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

A datapath interface is a connection point or protocol that allows data to flow between different components or modules within a computer system

Debugging a datapath involves diagnosing and resolving issues related to the flow of data and control signals through the datapath components. Debugging a datapath involves gaining an understanding of a datapath architecture, including its components, data paths, control signals, and how they interact during instruction execution. Debugging then involves determining the nature of the problem encountered. Common issues include incorrect results, data corruption, stalls, or hangs during execution. Debugging tools are used such as logic analyzers, oscilloscopes, or simulation environments to observe the signals propagating through the datapath during execution. This helps identify anomalies or discrepancies in the expected behavior. Debugging then involves trace execution where the execution of instructions is traced through the datapath to identify where the problem occurs. This may involve setting breakpoints in the code or using simulation tools to step through the execution cycle-by-cycle.

After tracing is complete, data paths and control signals are checked. It is verified that data is flowing correctly through the various components of the datapath. It is also ensured that control signals are being generated and propagated correctly to control the operation of the datapath components. It is verified that the control signals are synchronized with the execution of instructions and that they activate the appropriate datapath resources. The timing is then analyzed by checking the timing of signals and operations within the datapath to identify any timing violations or delays that may be causing issues.

Debugging a datapath can be complex and time-consuming, involving a deep understanding of the datapath architecture and careful analysis of signals and behaviors. However, thorough debugging is essential for ensuring the reliability and performance of the system.

Event counters and logic analyzers are tools used in digital design and debugging to analyze the behavior of digital systems. While they serve different purposes, they are often used together to gain a comprehensive understanding of system performance and behavior.

Event counters, also known as performance counters or hardware counters, are specialized registers used to count specific events or occurrences during program execution or system operation. These events can include instructions executed, cache hits/misses, branch predictions, memory accesses, and various other system-level events.

Event counters provide valuable insights into system performance, allowing developers to analyze bottlenecks, identify inefficiencies, and optimize code or system design. By monitoring the counts recorded by event counters, developers can pinpoint areas for improvement and make informed decisions to enhance system performance.

Logic analyzers are test instruments used to capture and analyze digital signals in digital systems. Logic analyzers typically consist of multiple input channels, a high-speed sampling mechanism, and sophisticated triggering capabilities. Logic analyzers allow developers to observe the behavior of digital signals in real-time, helping to debug and analyze complex digital circuits.

With a logic analyzer, developers can capture and display digital signals from various points in a system simultaneously, enabling them to trace signal paths, detect timing violations, identify protocol errors, and debug logic and timing issues.

Event counters and logic analyzers are often used together in digital design and debugging workflows to gain a comprehensive understanding of system behavior and performance. Event counters provide high-level performance metrics and insights into system-level events, while logic analyzers offer detailed visibility into the behavior of individual signals and components within the system.

Such debugging solutions offer interface transaction counts as an instantaneous state observation, but are unable to capture transitory spikes in activity often associated with functional issues or performance stutters. Existing solutions are deficient in determining the root cause of a failure because once an error condition occurs, an extended sequence of datapath events can obscure the original issues.

In contrast, the example embodiments allow the programmer to freeze the datapath state chip-wide after the first error or special event occurs, thus enabling debugging of the issue without additional noise. Also, capturing event counters based on a common schedule of programmable pulse width and pulse frequency allows the programmer to study transitory states across the chip during a performance analysis test. The example embodiments thus offer an improvement on these existing mechanisms (i.e., event counters and logic analyzers) by allowing the programmer to examine the chip state at the time of an event of interest and across sample windows of programmable width and frequency.

The example embodiments further provide the ability to freeze a datapath chip-wide after detection of a particular event. This particular event could be an interrupt or error or a trigger. When a freeze is triggered by the particular event, the datapath stops or is paused, but all the control registers/memory can still be read by software. This provides debug information at a particular moment (i.e., during the freeze state of the debug circuit). The example embodiments further provide the ability to capture targeted windows in time of event counters, synchronized across the chip with programmable window frequency and duration. Every block within the chip has a synchronized timestamp, and all event counters start and latch at the same time across the chip. This provides a full view of one particular time window. Additionally, the example embodiments provide the ability to measure latency across the chip.

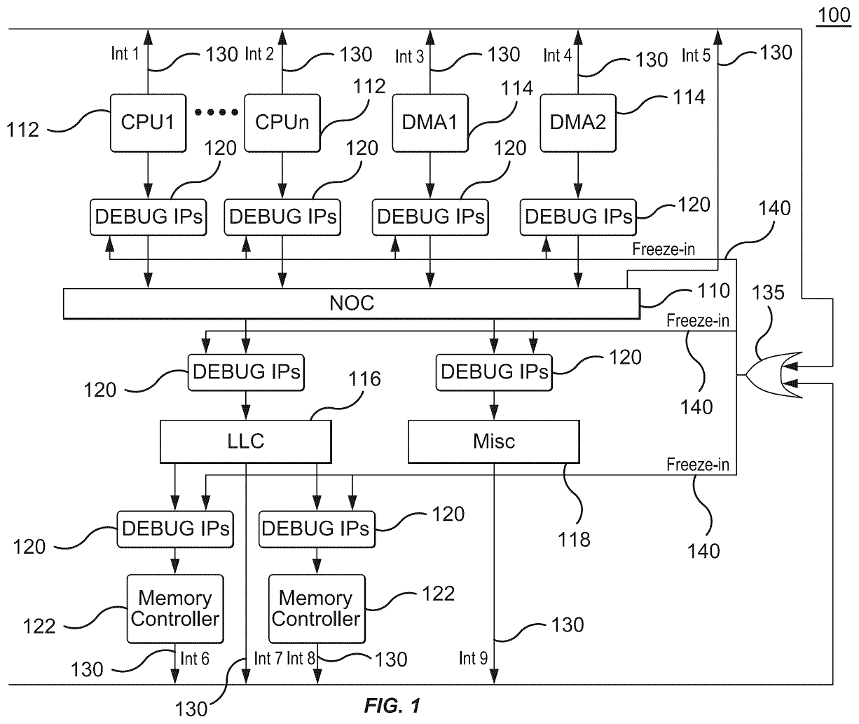

FIG. 1 illustrates a system 100 including a network-on-chip (NoC) in communication with various components, where a debug circuit is coupled to each component, according to an example.

The system 100 can be referred to as an integrated circuit (IC). The NoC 110 is an in-chip network that connects IP blocks and components, and routes data packets among them using switches. The NoC 110 enables data to move between heterogeneous computing elements, while at the same time minimizing resources used to connect them.

CPUs 112 and direct memory access (DMA) 114 are coupled to the input of the NoC 110. A debug circuit 120 may be placed between each of the CPUs 112 and the NoC 110. A debug circuit 120 may be placed between each of the DMA 114 coupled to the NoC 110.

Other elements or components may be coupled to the output of the NoC 110. In one example, a last level cache (LLC) 116 and other miscellaneous components 118 can be coupled to the NoC 110. A debug circuit 120 may be placed between the NoC 110 and the LLC 116. A debug circuit 120 may also be placed between the NoC 110 and each of the miscellaneous components 118. The LLC 116 may be coupled to a plurality of memory controllers 122. A debug circuit 120 may also be placed between the LLC 116 and each of the memory controllers 122. Therefore, a debug circuit 120 can be associated with every component communicating with the NoC 110.

A logic gate 135 is also provided to collect all the interrupts 130 from all the components. In one example, the logic gate 135 may be an OR gate. The interrupts 130 may be collected from the CPUs 112, the DMAs 114, the LLC 116, the memory controllers 122, and other miscellaneous components 118. The interrupts 130 can be propagated to the debug circuits 120 to trigger the freeze state. The logic gate 135 may thus send signals 140 (freeze_in) to the debug circuits 120 to trigger the freeze state of all the logic blocks within the system. The signals 140 are distributed across the chip.

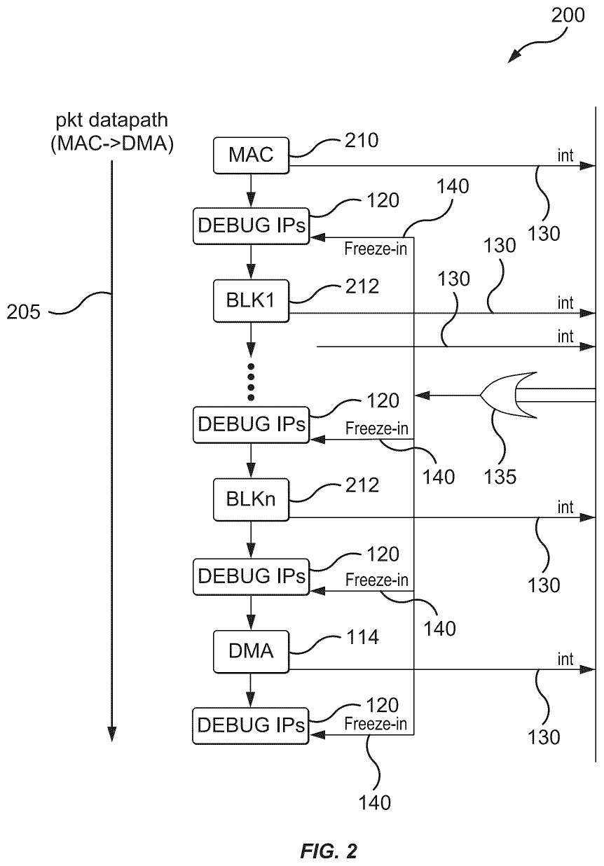

FIG. 2 illustrates a datapath including a plurality of logic blocks, according to an example.

The datapath 205 includes a media access control (MAC) block 210, the DMA 114, and a plurality of logic blocks 212 disposed between the MAC block 210 and the DMA 114. A debug circuit 120 may be placed between all of the components or blocks. As such, a debug circuit 120 is placed between the MAC block 210 and the first logic block. A debug circuit 120 is placed between the first logic block and the second logic block. A debug circuit 120 is placed between all of the plurality of logic blocks 212. A debug circuit 120 is placed before and after the DMA 114. Therefore, each component or element or block of the datapath 205 may be associated with or in communication with a debug circuit 120.

In one example, the datapath 205 is a packet datapath or a packet bus interface. In other examples, the datapath 205 may be an Advanced extensible Interface (AXI) datapath.

A logic gate 135 is also provided to collect all the interrupts 130 from all the components. In one example, the logic gate 135 may be an OR gate. The interrupts 130 may be collected from the MAC block 210, BLK1, BLKn (the plurality of logic blocks 212), and the DMA 114. The interrupts 130 can be propagated to the debug circuits 120 to trigger the freeze state. The logic gate 135 may thus send signals 140 (freeze_in) to the debug circuits 120 to trigger the freeze state of all the logic blocks within the system. The signals 140 are distributed across the chip.

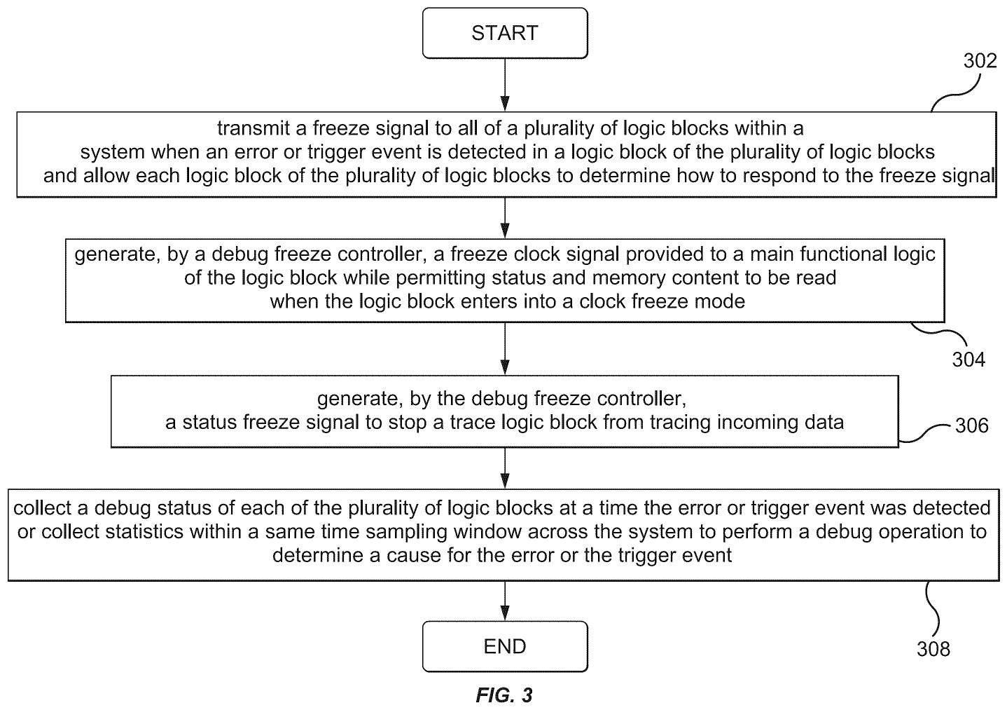

FIG. 3 illustrates a flowchart for implementing the debug circuit of FIG. 1 to freeze signals to the datapaths of the system, according to an example.

At block 302, transmit a freeze signal to all of a plurality of logic blocks within a system when an error or trigger event is detected in a logic block of the plurality of logic blocks and allow each logic block of the plurality of logic blocks to determine how to respond to the freeze signal.

At block 304, generate, by a debug freeze controller, a freeze clock signal provided to a main functional logic of the logic block while permitting status and memory content to be read when the logic block enters into a clock freeze mode.

At block 306, generate, by the debug freeze controller, a status freeze signal to stop a trace logic block from tracing incoming data.

At block 308, collect a debug status of each of the plurality of logic blocks at a time the error or trigger event was detected or collect statistics within a same time sampling window across a system to perform a debug operation to determine a cause for the error or the trigger event.

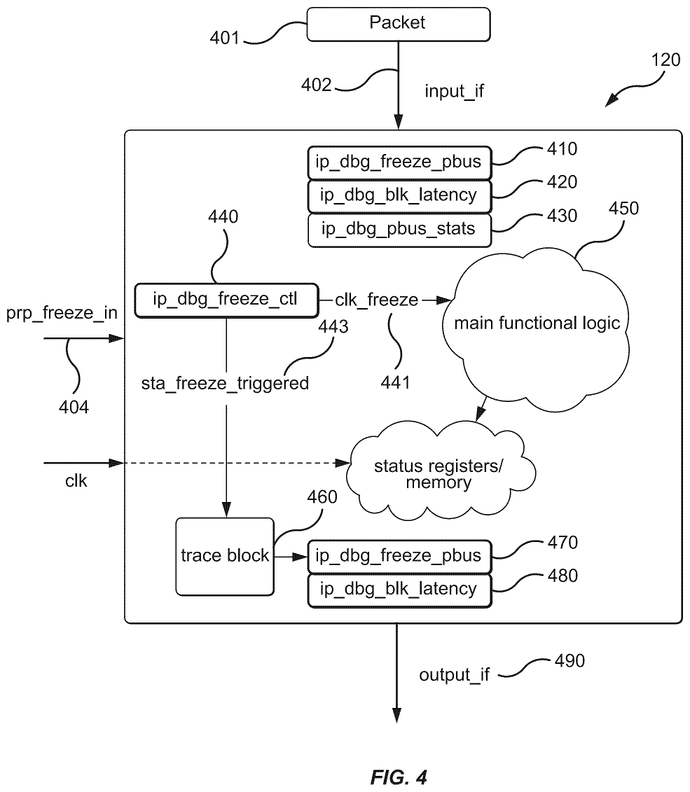

FIG. 4 illustrates a debug circuit, according to an example.

The debug circuit 120 includes an input 402 (input_if) and an output 490 (output_if). In one example, the input 402 may be a packet 401. As such, the datapath may be a packet bus. When the packet 401 enters the debug circuit 120, the packet 401 may be processed by three logic blocks. The first logic block is a packet freeze logic bus 410 (ip_dbg_freeze_pbus), the second logic block is a latency logic block 420 (ip_dbg_blk_latency), and the third logic block is a packet bus statistics logic block 430 (ip_dbg_pbus_stats). The latency logic block 420 can be referred to as latency circuitry and the packet bus statistics logic block 430 can be referred to as interface statistics circuitry depending on the interface protocol.

When the packet 401 exits the debug circuit 120, the packet is processed by two logic blocks. The logic blocks at the output side of the debug circuit 120 are a first logic block referred to as a packet bus freeze logic bus 470 and a second logic block referred to as a latency logic block 480.

The debug circuit 120 also includes a freeze control block 440 (ip_dbg_freeze_ctl). The freeze control block 440 can also be referred to as a debug freeze controller. The freeze control block 440 receives a trigger signal. The trigger signal can be a freeze signal 404 (freeze_in). The freeze signal 404 may be triggered by logic blocks of the datapath. Any of the logic blocks of the datapath may trigger the freeze signal 404. In other words, any of the logic blocks of the datapath may trigger the debug circuit 120 to enter into a freeze state.

When the freeze control block 440 receives the freeze signal 404, a clock freeze signal 441 (clk_freeze) is generated. The clock freeze signal 441 is transmitted to a main functional logic block 450 that can freeze all the logic blocks of the datapath. The status of the main functional logic block 450 can be stored in registers and memory 455. Software (SW) could read all the registers and memory 455 which are in a freeze state when the error is detected. The freeze control block 440 can also send a signal, e.g., a status signal 443 (sta_freeze_triggered) to the trace logic block 460 to stop the trace logic block 460 from further tracing.

Therefore, when an error or trigger event is detected, the debug circuit 120 enters into the freeze mode. The status of each of the logic blocks is recorded or stored in the trace logic block 460 to allow a user to access the trace logic block 460 to determine what the error or trigger event is. Stated differently, the data or information, such as state information or statistics information, previously received by the debug circuit 120 is maintained and stored. A programmer can access the previously stored data or information to perform a debug operation. Thus, the fact that the debug circuit 120 entered the freeze state, does not wipe out the previous information. The previously traced information is maintained in the trace logic block 460.

For example, a logic block that triggered the freeze of the debug circuit 120 may include trace logic. The trace logic may include an instruction being traced. The instruction may be traced and stored in a buffer. When the logic block enters into the freeze state via the status signal 443, and the software is configured as freeze_trace_en, the trace of the instruction can be stopped or suspended without affecting the traffic. Thus, the instruction is stopped from being written into the buffer. However, the tracing message or tracing information generated before the freeze signal 404 was generated is maintained within the trace logic block 460. Such information written before the freeze signal 404 was generated allows for the user or programmer to initiate or perform a debug operation to determine what caused the error or trigger event at the time of the freeze state without stopping the system traffic.

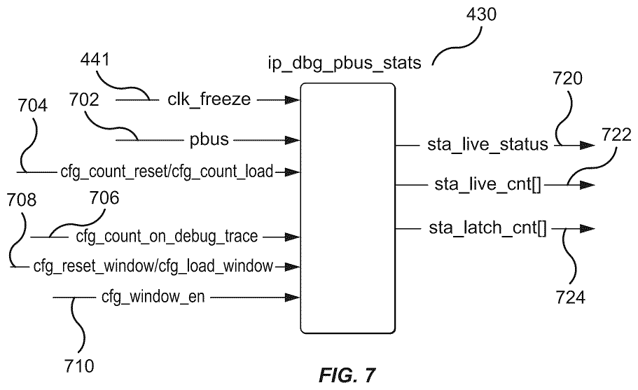

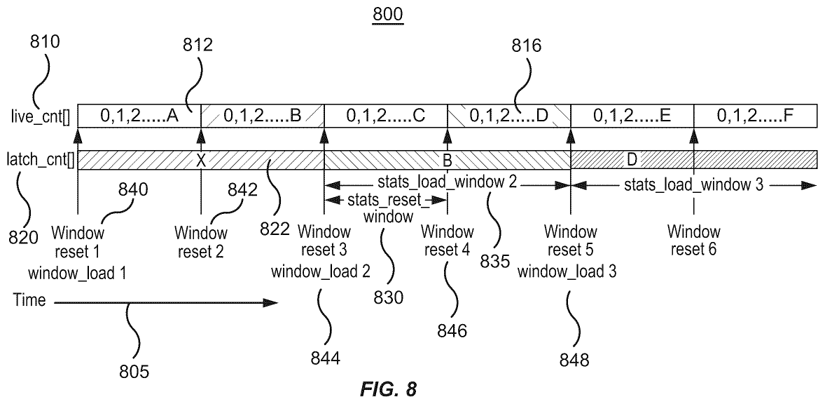

In summary, the debug circuit 120 may be integrated into datapaths of the system to monitor internal chip interfaces, such as packet buses, AXI buses, or other common datapath interfaces. When an error or special event (i.e., trigger event) is detected, the freeze can propagate to all the logic blocks of the datapath of the chip, and trigger the debug circuit 120 to enter into a freeze state. When the debug circuit 120 enters into the freeze state, the debug circuit 120 may freeze the clock (clk) sent to the main functional logic block 450. The clk_freeze signal 441 may be frozen. The status information or statistics information is maintained and stored when the debug circuit 120 enters the freeze state. The debug circuit 120 may also stop the trace logic block 460 from recording additional log data from the tracing. As such, the data or information previously written in the trace logic block 460 is not overwritten. This previously written information in the trace logic block 460 is used to initiate or perform the debug operation. In one example, the debug circuit 120 may also backpressure the input interface to not accept any more input (e.g., packets if the input interface is a packet interface). In another example, the debug circuit 120 may drop additional packets entering from the input interface, or single step the packets coming into the debug circuit 120 from the packet interface. Moreover, interface counters may be monitored during periodic sampling windows, thus allowing counters to be harvested in response to synchronized, narrow time windows across the chip or system, as described below with reference to FIGS. 7 and 8.

On the output side of the debug circuit 120, the first logic block is the packet bus freeze logic bus 470 and the second logic block is the latency logic block 480. The purpose of the packet freeze logic bus 470 is to maintain proper packet flow. When the debug circuit 120 enters into the freeze state and the freeze control block 440 generates the clock freeze signal 441, the packet bus freeze logic bus 470 ensures that a logic block A does not affect the operation of logic block B on the datapath. Stated differently, the packet bus freeze logic bus 470 ensures that the input interface protocol is not broken.

Further, the packet freeze logic bus 410, the latency logic block 420, the freeze control block 440, packet freeze logic bus 470, and the latency logic block 480 are bolded to indicate that such blocks use an always-on clock. The rest of the blocks may use a clock freeze. Even when such blocks are freezes, the content of the registers and memory 455 may still be read using the always-on clock.

Therefore, according to FIG. 4, when an error or trigger event from any logic block occurs in the entire system, a freeze signal is transmitted to all the logic blocks to/from CPU/NOC and all other logic blocks in the datapath. Each logic block has a debug circuit 120, which propagates a clock freeze signal to the main logic of the block (or main functional logic), thus allowing software to analyze the error condition at the moment it occurred. The debug circuit 120 further monitors an interface status, counting events, and making status and counter values visible to the software via the control register interface. Each debug circuit 120 is light-weighted, and together, the configuration provides a distributed way to collect all the debug status at the exact same error moment or all the statistics within the same time window across the chip. This method is considered a distributed way of debugging.

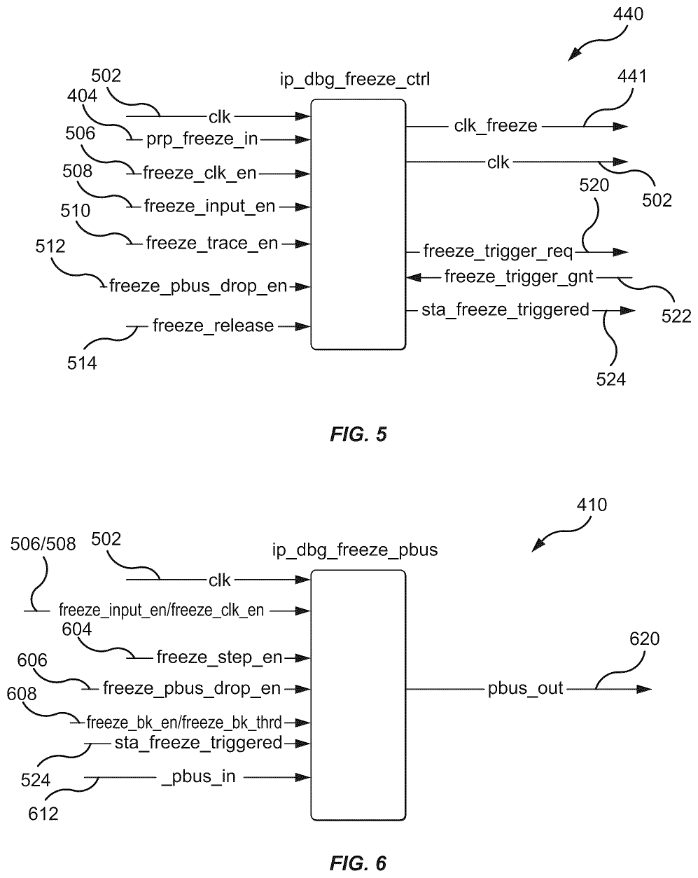

FIG. 5 illustrates a freeze control function of the debug circuit, according to an example.

The freeze control block 440 may receive or process several different signals. For example, the freeze control block 440 may receive a clock signal 502 and the trigger signal, which is the freeze signal 404 (freeze_in). The freeze control block 440 may further receive a clock freeze signal 506 (freeze_clk_en), an input freeze signal 508 (freeze_input_en), and a trace freeze signal 510 (freeze_trace_en).

The input freeze signal 508 is configured to enable the backpressure operation or the single-step operation. The backpressure operation involves stopping or preventing all incoming packets from entering the debug circuit 120 and the single-step operation involves allowing one packet at a time to enter the debug circuit 120. The single-step operation may be performed right after the backpressure operation is initiated.

The trace freeze signal 510 is configured to stop the tracing and write the debug information into a buffer.

The freeze control block 440 may further receive a packet drop freeze signal 512 (freeze_pbus_drop_en) and a freeze release signal 514 (freeze_release).

The packet drop freeze signal 512 can be employed instead of the input freeze signal 508. In other words, instead of applying the backpressure operation to stop all incoming packets, the packet drop operation allows dropping the packet at the input buffer so that the new packet does not interfere with a status of the logic block.

The freeze release signal 514 allows for the release of the freeze on the debug circuit 120. The freeze release signal 514 may be triggered, e.g., after the user or programmer has identified the cause of the error or trigger event.

The output of the freeze control block 440 may include the clock signal 502 and the clock freeze signal 441. The clock freeze signal 441 maintains the error state so that the debug operation can be performed.

The output of the freeze control block 440 may further include three signals pertaining to handshaking operations. The outputs may include a freeze trigger request signal 520 (freeze_trigger_req), a freeze grant signal 522 (freeze_trigger_gnt), and a freeze status signal 524 (sta_freeze_triggered). The request and grant signals provide a handshake between the freeze control block and the main functional block to enter into the freeze mode.

In summary, the freeze control block 440 puts the logic block into a freeze state when an error has been detected or when a special event has been detected. Additionally, when the logic block is already in a freeze state, a release mechanism is available to bring the logic block out of the freeze state. When the logic block is in the freeze state, the clock can also be put in the freeze state. The main functional logic block 450 receives the clock freeze signal 441, so that the main functional logic block 450 may also be put in a freeze state. However, the register read/write is still functional by using the clock signal 502. As such, the internal logic may be put in a freeze state when an error or special event is determined or identified.

FIG. 6 illustrates a packet bus freeze function of the debug circuit, according to an example.

The packet freeze logic bus 410 illustrates the packet bus input 612 and the packet bus output 620. When nothing has been enabled, the packet freeze logic bus 410 allows the packet bus input 612 to go through as the packet bus output 620. Apart from the clock signal 502, the packet freeze logic bus 410 receives or processes several signals. For example, when the freeze status signal 524 is triggered, the clock freeze signal 506 and the input freeze signal 508 are enabled. Once in the freeze state, a step signal 604 or a packet drop signal 606 can be triggered.

The wait signal 608 provides a waiting period for how long it takes to perform the handshake. Thus, a threshold is set for the wait before handshake permission is provided. In one example, the wait may be 2 k cycles. In other words, if a response is not received within 2 k cycles, a freeze state may be triggered. This wait operation may be considered a special trigger event for entering the freeze state. Once in the freeze state, the debug circuit 120 can perform a debug operation to determine why a handshake wasn't provided within a 2k cycle. This may also be referred to as the backpressure time.

In summary, the packet freeze logic bus 410 provides for a pass through, that is, the packet bus input 612 can go through as the packet bus output 620 when no freeze state is detected. In other words, pbus_out is equal to pbus_in. However, when the packet freeze logic bus 410 enters into the freeze state, based on the configuration, multiple operations may take place.

In one instance, the packet freeze logic bus 410 may backpressure the packet bus input 612 so that no new or incoming packets can enter into the debug circuit 120.

In another instance, the packet freeze logic bus 410 may single step the packet bus interface such that one packet at a time enters the debug circuit 120.

In yet another instance, the packet freeze logic bus 410 may drop the following packets at the packet boundary.

In yet another instance, the packet freeze logic bus 410 may monitor the backpressure time, when it reaches a configurable threshold, and can generate an interrupt to trigger the block to enter into the freeze state.

FIG. 7 illustrates a packet bus statistics function of the debug circuit, according to an example and FIG. 8 illustrates a timing diagram 800 of the packet bus statistics function of the debug circuit, according to an example.

The packet bus statistics logic block 430 may be used during performance analysis.

The packet bus statistics logic block 430 may receive a packet 702 and multiple counters may be triggered. Also, the packet bus statistics logic block 430 may keep track of a live status 720 of the packet bus, a live status counter 722, and a latch status counter 724.

The packet bus statistics logic block 430 includes two sets of counters. The first counter is a live counter and the second counter is a latch counter. The counter enable signals include a count reset, count load signal 704, a count debug trace counter signal 706, and a reset and load count window signal 708.

When the window_en signal 710 is disabled, the SW may use the count reset, count load signal 704 to latch the live counter into the latch counter, and meanwhile reset the live counter. In other words, the SW may control the count window, which may not be accurate.

The count debug trace counter signal 706 counts when the debug_trace is on. The debug trace is a control field in the packet header, which can be defined by the SW. For example, it can define a flow so that the packet bus statistics logic block 430 can have per flow-based statistics.

When the window_en signal 710 is enabled, the reset and load count window signal 708 provides control to reset the live counter, and latch the live counter by hardware (HW), automatically, in a given configurable reset_window and load_window.

When the window_en signal 710 is enabled, the packet bus statistics logic block 430 provides for a hardware mechanism to perform the load and reset at the time window programed by SW (i.e., the reset and load count window signal 708). For example, when multiple logic blocks are in the datapath 205, all the logic blocks (e.g., 210, 212, 114) counts are at the same time window across the chip, which provides a better view of the statistics across the chip.

The timing diagram 800 depicts counters each having an ideal sampling period or window. In this example, five sampling windows along time axis 805 are shown for illustrations purposes. At a first point 840, a window reset occurs. As such, the first live counter register 812 of live counters 810 starts a count. The window reset occurs every sampling window. In one example, the reset may be every 1 um or every 2 um or every 10 um. It is noted that the load window 835 could be N times the reset window. In FIG. 8, for example, it is twice the size of the reset window 830. This configuration allows the CPU 112 enough time to read all the latched registers to determine the cause of the error or trigger event especially when the reset window is very small.

At 844, another window reset occurs. The data B in the live counter register 812 has to be loaded to the latch counter. At that time, SW can use the load window 835 to harvest the data stored in the latch counter. The SW can trigger the debug circuit 120 to debug the data stored in the latch counter.

After this, the live counters 810 can start the count again at the point 844, the point 846, and the point 848, respectively, where the third, fourth, and fifth window reset occurs. The live counter 816 is latched at the point 848, and the latch_cnt becomes D.

Going back to the datapath 205, which includes a plurality of logic blocks, e.g., maybe up to 100 logic blocks, each logic block has a timestamp. The timestamps of the logic blocks are in synchronization with each other. All the logic blocks on the datapath 205 will start a same count in a time window or sampling period. Software can be used to harvest the data from each of the logic blocks on the datapath and determine a status of each of the logic blocks. However, if there are 100 logic blocks on the datapath 205, then it would take a long time to harvest the data or information from the 100 logic blocks. By using two counters, the live counters 810 and the latch counters 820, the CPU 112 coupled to the NoC 110 is provided with enough time to read all the data or information in a sample period or time window. The CPU 112 can thus read all the statistics from all the logic blocks on a datapath during a same, small time window. Stated differently, a same time sample of each of the logic blocks of the datapath can be extracted to evaluate performance of the chip at that time sample across all of the logic blocks on the datapath.

In summary, the packet bus statistics logic block 430 provides statistics for the packet interface, counts packet bus utilization cycles, xoff cycles and idle cycles, provides live status of the packet bus, and counts based on the packet flow. Each count has two physical counters, that is, one live counter and one latch counter. The live counter keeps counting and the latch counter loads counters from the live count when load window is up. The packet bus statistics logic block 430 may count based on the time window across the chip or system. In one example, there could be two configurable windows, that is, a reset window 830 to determine the sample period and a load window 835 to determine the duration the latched values are being held. This allows the CPU 112 enough time to read all the latched registers before the ideal sample period ends. The packet bus statistics is one example. In another example, it could be an AXI bus statistics. However, other interface protocol statistics may be implemented by using the same window and live/latch counter configuration.

With such flexible statistics, the utilization of the packet bus can be determined, and since all the logic blocks across the chip use the same window configuration and timestamp, statistics across the whole chip can be provided to acquire a full view of the chip performance.

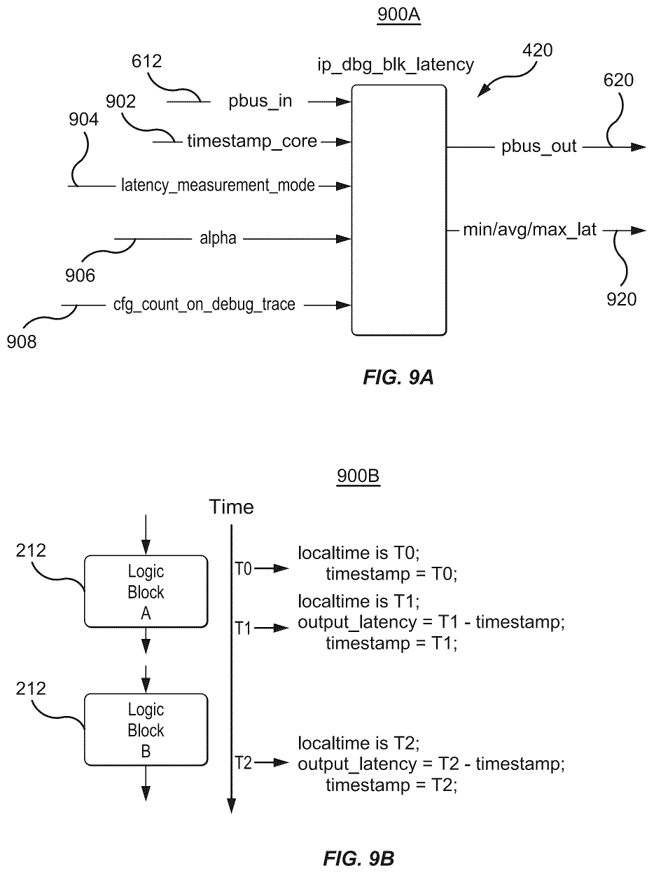

FIG. 9A illustrates a packet latency function 900A of the debug circuit, according to an example and FIG. 9B illustrates a packet processing 900B of the packet latency function of the debug circuit, according to an example.

The latency logic block 420 is used to determine latency for the traffic flowing through the datapath, the traffic referring to the logic blocks of the datapath.

The latency logic block 420 illustrates the packet bus input 612 and the packet bus output 620. When nothing has been enabled, the packet freeze logic bus 410 allows the packet bus input 612 to go through as the packet bus output 620. Stated differently, when the debug operation is inactive, then the packet bus input 612 goes right through as the packet bus output 620.

The latency logic block 420 has various inputs, such as, a timestamp signal 902, a latency measurement mode signal 904, an alpha signal 906, and a debug trace signal 908. The timestamp signal 902 is the same across all of the logic blocks on the datapath 205. The alpha signal 906 provides the weight of new incoming latency add-ons to the existing average latency for the average latency calculation.

The latency logic block 420 also has an output, that is, latency report signal 920. The latency report signal 920 provides the minimal, average, and maximum latency of one logic block on the datapath 205.

The latency logic block 420 is used to determine latency measurements through each logic block. For example, the latency logic block 420 measures the latency of logic block A and the latency of logic block B, as shown in FIG. 9B. Once all the latency measurements are made, SW may add up all the latencies to acquire the overall latency on the datapath 205. Also, SW may identify which logic block has abnormal latency, which could indicate some issues.

In the diagram showing the packet processing 900B, a packet goes through the logic blocks of the datapath 205. The packet header includes a timestamp. Time TO is a time when a packet is received by logic block A. Time T1 is a time when the packet exits the logic block A. As such, a timestamp is generated when the packet enters logic block A and a timestamp is generated when the packet exits the logic block A. The latency can be measured by calculating T1−T0.

The packet exiting logic block A is received by logic block B at time T1. T1 is the time when the packet is received by logic block B. Time T2 is a time when the packet exits the logic block B. As such, a timestamp is generated when the packet enters logic block B and a timestamp is generated when the packet exits the logic block B. The latency can be measured by calculating T2−T1.

If the datapath 205 includes, e.g., 30 logic blocks, the min, max and average latency of each logic block can be measured. Also, there is a debug_trace signal 908, which can aid the latency logic block to measure latency of one flow.

The latency logic block 420 may be used when a packet bus is used as a datapath interface. If the datapath interface is an AXI bus or other protocol bus, the same methodology may be used to measure an AXI latency if needed.

In summary, the latency logic block 420 is used to measure packet pass through min/max/average latency for logic blocks in a datapath. A timestamp field in the packet header is employed. When a packet is received by the logic block, a current time is inserted into the packet header. When the packet exits the logic block, subtract the current time from the timestamp in the packet header to obtain the latency. The latency logic block 420 provides for the latency in each logic block and provides for the total latency across the chip.

In conclusion, the example embodiments provide the ability to freeze a datapath chip-wide after detection of a particular event. This particular event could be an interrupt or a trigger. When a freeze is triggered by the particular event, the datapath stops, but all the control registers can still be read by software. This provides inside debug information at a particular moment. The example embodiments further provide the ability to capture targeted windows in time of event counters, synchronized across the chip with programmable window frequency and duration. Every block within the chip has a synchronized timestamp, and all event counters start and latch at the same time across the chip. This provides a full view of one particular time window. Additionally, the example embodiments provide the ability to measure latency across the chip. The example embodiments provide for a debug circuit that advantageously monitors peak performance by using a time window based statistic. The debug circuit can advantageously stop or pause the datapath at any particular moment when an error or trigger event is detected, to review and evaluate information already processed at the time the debug circuit enters the freeze state. The example embodiments can measure datapath bandwidth, latency, and backpressure to allow a programmer to examine the chip or system at the time of the event or error across sample windows of programmable width and frequency.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
a debug circuit placed within the system with connectivity to a central processing unit (CPU), the system configured to:
transmit a freeze signal to all of a plurality of logic blocks within the system when an error or trigger event is detected in a logic block of the plurality of logic blocks and allow each logic block of the plurality of logic blocks to determine how to respond to the freeze signal; and
generate, by a debug freeze controller, a freeze clock signal provided to a main functional logic of the logic block while permitting status and memory content to be read when the logic block enters into a clock freeze mode.

2. The system of claim 1, wherein a status freeze signal is generated by the debug freeze controller to stop a trace logic block from tracing incoming data.

3. The system of claim 2, wherein a debug status of each of the plurality of logic blocks is collected at a time the error or trigger event was detected.

4. The system of claim 2, wherein statistics are collected within a same time sampling window across the system to perform a debug operation to determine a cause for the error or the trigger event.

5. The system of claim 1, wherein the debug circuit further includes latency circuitry configured to measure minimum, maximum, and average latency of each of the logic blocks to determine a distribution of overall latency among the plurality of logic blocks.

6. The system of claim 1, wherein the debug circuit further includes interface statistics circuitry configured to provide statistics for a packet interface, an Advanced extensible Interface (AXI) interface, or other protocol interface to count at least utilization cycles and backpressure cycles.

7. The system of claim 6, wherein the interface statistics circuitry includes a live counter and a latch counter.

8. The system of claim 1, wherein the debug circuit monitors interface counters during a time sampling window across all the logic blocks of the system.

9. The system of claim 8, wherein the time sampling window includes a reset window to determine a sample period and a load window to determine a duration of latched values in latch counters.

10. The system of claim 9, wherein the load window is N times of a size of the reset window, where N is an integer greater than 0.

11. An integrated circuit (IC), comprising:
a datapath; and
a debug circuit in communication with the datapath, the IC configured to:
transmit a freeze signal to all of a plurality of logic blocks within the IC when an error or trigger event is detected in a logic block of the plurality of logic blocks and allow each logic block of the plurality of logic blocks to determine how to respond to the freeze signal; and
generate, by a debug freeze controller, a freeze clock signal provided to a main functional logic of the logic block while permitting status and memory content to be read when the logic block enters into a clock freeze mode.

12. The IC of claim 11, wherein a status freeze signal is generated by the debug freeze controller to stop a trace logic block from tracing incoming data.

13. The IC of claim 12, wherein a debug status of each of the plurality of logic blocks is collected at a time the error or trigger event was detected.

14. The IC of claim 12, wherein statistics are collected within a same time sampling window across the IC to perform a debug operation to determine a cause for the error or the trigger event.

15. The IC of claim 11, wherein the debug circuit further includes latency circuitry configured to measure minimum, maximum, and average latency of each of the logic blocks to determine a distribution of overall latency among the plurality of logic blocks.

16. The IC of claim 11, wherein the debug circuit further includes interface statistics circuitry configured to provide statistics for a packet interface, an Advanced extensible Interface (AXI) interface, or other protocol interface to count at least utilization cycles and backpressure cycles.

17. The IC of claim 16, wherein the interface statistics circuitry includes a live counter and a latch counter.

18. The IC of claim 11, wherein the debug circuit monitors interface counters during a time sampling window across all the logic blocks of the IC.

19. The IC of claim 18, wherein the time sampling window includes a reset window to determine a sample period and a load window to determine a duration of latched values in latch counters, wherein the load window is N times a size of the reset window, where N is an integer greater than 0.

20. A method comprising:
placing a debug circuit within a system with connectivity to a central processing unit (CPU) to:
transmit a freeze signal to all of a plurality of logic blocks within the system when an error or trigger event is detected in a logic block of the plurality of logic blocks and allow each logic block of the plurality of logic blocks to determine how to respond to the freeze signal; and
generate, by a debug freeze controller, a freeze clock signal provided to a main functional logic of the logic block while permitting status and memory content to be read when the logic block enters into a clock freeze mode.
